(19) United States
(12) Patent Application Publication
(10) Pub. No.: US 2011/0282605 A1
(43) Pub. Date: Nov. 17, 2011

(54) MOTOR DRIVING CIRCUIT

(75) Inventor: Tatsuro SHIMIZU, Ukyo-Ku (JP)

(73) Assignee: ROHM CO., LTD., Kyoto (JP)

(21) Appl. No.: 13/045,656

(22) Filed: Mar. 11, 2011

(30) Foreign Application Priority Data
Mar. 12, 2010 (JP) JP2010-055335

(51) Int. Cl. G06F 19/00

(52) U.S. Cl. 702/65

(57) ABSTRACT

A test signal generating circuit generates an AC test signal. A driving unit supplies, to a motor, a driving voltage on which the test signal has been superimposed. A current detection circuit generates a detection signal that corresponds to an actual current that flows through a coil of the motor. A filter extracts, from the detection signal, a frequency component that corresponds to the test signal. A coil constant calculation circuit calculates the resistance value and the inductance value of the motor based upon the amplitude of the detection signal output from the filter, the amplitude of the test signal, and the phase difference between these signals.

### BACKGROUND OF THE INVENTION

1. Field of the Invention

The present invention relates to a sensorless motor driving technique.

2. Description of the Related Art

There are two known methods for driving a DC motor or a spindle motor, i.e., a method using a Hall sensor or a velocity sensor, and a sensorless driving method using back electromotive force that occurs in a coil of a motor without involving a sensor. With a method using such a sensor, it is difficult to suppress the effects of irregularities in such sensors.

In contrast, with such a sensorless driving method, assuming that the resistance and the inductance of the coil are known, the back electromotive force is estimated, and the estimated value of the back electromotive force is used in the driving operation for the motor. With typical arrangements, after the resistance value and the inductance value of the coil are measured, the same values are used continuously.

### RELATED ART DOCUMENTS

### Patent Documents

### [Patent Document 1]

Japanese Patent Application Laid Open No. 2005-224100

### [Patent Document 2]

### Japanese Patent Application Laid Open No. 2000-166285

It is known that the resistance and the inductance of a motor are each subject to the effects of temperature. In particular, with a fan motor configured to cool a CPU (Central Processing Unit) or the like, the temperature of the coil changes in a wide range. This leads to large fluctuation in the resistance and the inductance, resulting in it becoming difficult to precisely estimate the back electromotive force. If the back electromotive force cannot be estimated with sufficient precision, such an arrangement has a problem of large vibration or large noise of the motor, or otherwise a problem of large power consumption. Such problems do not occur only in such a fan motor, but also occur in a driving operation for driving any other kind of motor using a sensorless method.

### SUMMARY OF THE INVENTION

The present invention has been made in view of such a situation. Accordingly, it is an exemplary purpose of the present invention to provide a motor driving method for measuring the resistance and the inductance of a motor so as to estimate the back electromotive force thereof with high precision.

An embodiment of the present invention relates to a driving circuit configured to drive a motor having a resistance and an inductance. The driving circuit comprises: a test signal generating circuit configured to generate an AC test signal; a driving unit configured to supply, to the motor, a driving signal on which the test signal has been superimposed; a current detection circuit configured to generate a detection signal that corresponds to an actual current that flows through a coil; a filter configured to extract a frequency component that corresponds to the test signal from the detection signal; and a coil constant calculation circuit configured to calculate the resistance value and the inductance value of the motor based upon the amplitude of a detection signal output from the filter, the amplitude of the test signal, and the phase difference between these two signals.

With such an embodiment, the inductance and the resistance of the motor can be measured while the motor is being driven.

Also, the test signal generating circuit may be configured to adjust the frequency of the test signal such that the phase difference between the test signal and the detection signal output from the filter becomes a predetermined target value. Also, the target value may be substantially 45 degrees.

In such an arrangement, on the assumption that the phase difference matches the target value, the resistance value and the inductance value can be calculated by the coil constant calculation circuit. Thus, such an arrangement provides a simplified calculation operation.

Also, the coil constant calculation circuit may comprise a resistance estimator configured to calculate the resistance value of the motor by multiplying a value, which is obtained by dividing the amplitude of the test signal by the amplitude of the detection signal output from the filter, by a predetermined coefficient that corresponds to the target value.

Also, the resistance estimator may comprise: a first calculation unit configured to multiply the calculated resistance value by the amplitude of the detection signal output from the filter; a second calculation unit configured to calculate the difference between the output data of the first calculation unit and a value obtained by multiplying the amplitude of the test signal by a predetermined coefficient; a third calculation unit configured to convert the output data of the second calculation unit into multi-valued data; and a fourth calculation unit configured to generate the sum of data that represents the latest calculated resistance value and the output data of the third calculation unit so as to update the resistance value.

Also, the coil constant calculation circuit may comprise an inductance estimator configured to calculate the inductance value of the motor by dividing the resistance value thus calculated by a value that corresponds to the frequency of the test signal.

Also, the test signal generating circuit may comprise: a counter configured to generate count data having a sawtooth waveform having a period that corresponds to the frequency of the test signal; a CORDIC (COordinate Rotation DIgital Computer) configured to receive the count data from the counter, and to convert the count data thus received into a trigonometric function value; and an up/down counter configured to receive a first signal, which is obtained by converting, into binary data, data that is obtained by shifting the count data by an amount that corresponds to the target value, and a second signal, which represents the sign of the detection signal output from the filter, and to perform a counting up operation according to one of the data thus received, and to perform a counting down operation according to the other data thus received. Also, the counter may control the period of the count data based upon the output data of the up/down counter.

With such an embodiment, the up/down counter operates as a phase comparator, which provides a feedback operation such that phase difference between the test signal and the detection signal matches the target value.

A driving circuit according to an embodiment may further comprise a back electromotive force estimation circuit configured to generate a back electromotive force estimation signal that represents an estimated value of the back electromotive force that occurs in the motor, based upon a driving signal that corresponds to the driving voltage and the detection signal. Also, with the sampling period as dT, and with the resistance of the motor as R and the inductance of the motor as L, the back electromotive force estimation circuit may comprise: a ninth calculation unit configured to calculate the difference between the driving signal and the back electromotive force estimation signal; a tenth calculation unit configured to multiply the output data of the ninth calculation unit by dT/L; a current estimation circuit configured to estimate a current that flows through the coil, based upon the output data of the tenth calculation unit; and a back electromotive force calculation unit configured to generate the back electromotive force estimation signal such that the difference between the actual current value represented by the detection signal and the current value thus estimated becomes zero.

Also, the current estimation circuit may comprise: an eleventh calculation unit configured to multiply its estimated current value by (1−dT/L×R); a twelfth calculation unit configured to generate the sum of the output data of the tenth calculation unit and the output data of the eleventh calculation unit; and a delay circuit configured to delay the output data of the twelfth calculation unit by a period dT and to output the current value thus estimated as output data.

Also, the driving unit may adjust the phase of the driving voltage such that the timing of the zero-crossing point of a waveform of the estimated back electromotive force matches the timing of the zero-crossing point of the current represented by the detection signal.

Another embodiment of the present invention relates to a method for estimating the resistance and the inductance of a motor. The method comprises: superimposing an AC test signal on a driving voltage to be applied to the motor; generating a detection signal that corresponds to an actual current that flows through a coil included; extracting a frequency component that corresponds to the test signal from the detection signal; and calculating the resistance value and the inductance value of the motor based upon the ratio between the amplitude of the extracted detection signal and the amplitude of the test signal.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of an electronic device including a driving IC according to an embodiment;

FIG. 2 is a circuit diagram which shows a configuration of a back electromotive force estimation circuit;

FIG. 3A is a driving waveform diagram for a driving IC shown in FIG. 1, and FIG. 3B is a driving waveform diagram for an arrangement employing a Hall sensor;

FIG. 4 is a block diagram which shows a part of a configuration of the driving IC;

FIG. 5 shows graphs each showing the frequency response characteristics of the coil current with respect to the test signal supplied to the fan motor;

FIG. 6 is a circuit diagram which shows a specific example configuration of the driving IC shown in FIG. 4; and

FIGS. 7A through 7C are waveform diagrams each showing an operating waveform for the test signal generating circuit shown in FIG. 6.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B.

An embodiment of the present invention relates to a motor driving circuit configured to drive a DC motor. For example, such an embodiment is preferably used in a driving operation for a fan motor, a DC motor configured to drive a lens of a digital still camera, a DC motor configured to drive a pickup head unit included in an optical disk recording and playback apparatus for a CD (Compact Disc), DVD (Digital Versatile Disc), or the like.

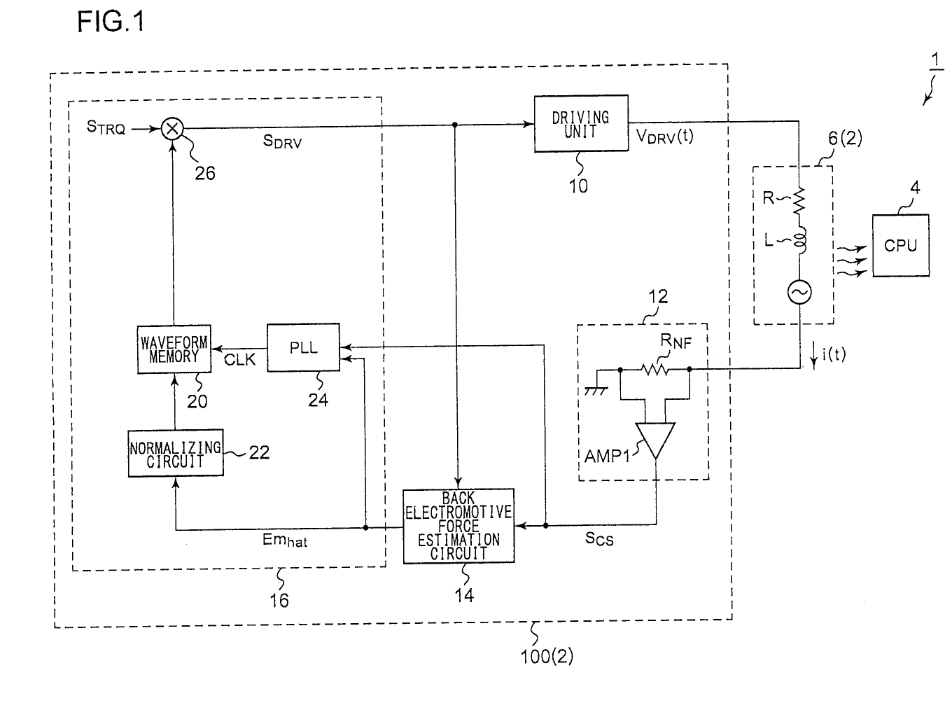

FIG. 1 is a circuit diagram which shows a configuration of an electronic device 1 including a driving IC 100 according to an embodiment. The electronic device 1 is configured as a desktop computer, a laptop computer, a workstation, a game device, an audio device, a video device, or the like, and includes a cooling apparatus 2 and a CPU (Central Processing Unit) 4. The cooling apparatus 2 includes a fan motor 6 arranged such that it faces the CPU 4, and a driving IC 100 configured to drive the fan motor 6.

The fan motor 6 includes a coil. The equivalent circuit of such a fan motor 6 is represented by a circuit comprising a resistor R and an inductance L connected in series. The back electromotive force Em(t) that occurs in the coil is represented by a power supply.

The driving IC 100 is a function IC integrated on a single semiconductor chip. The driving IC 100 estimates the back electromotive force Em(t) that occurs in the fan motor 6, and drives the fan motor 6 based upon the back electromotive force thus estimated. FIG. 1 is a simplified schematic configuration of the driving IC 100. It is needless to say that an arrangement may be made having a configuration that is equivalent to, or that is configured to perform an operation that is equivalent to, such an arrangement shown in FIG. 1, which is encompassed in the technical scope of the present invention.

The driving IC 100 includes a driving unit 10, a current detection circuit 12, a back electromotive force estimation circuit 14, and a driving signal generating unit 16. The driving unit 10 applies a driving voltage V_{DRV}(t) that corresponds to a driving signal S_{DRV} to the fan motor 6. The configuration of the driving unit 10 is not restricted in particular. Rather, various known techniques may be used to configure the driving unit 10. For example, with an arrangement configured to perform a BTL driving operation, the driving voltage V_{DRV}(t) is an analog voltage which is continuous over time. On the other hand, with an arrangement configured to perform a PWM driving operation, the driving voltage V_{DRV}(t) has a switching waveform.

The current detection circuit 12 generates a detection signal S_{CS} that corresponds to the driving current i_{DRV}(t) that flows through the coil of the fan motor 6. For example, the current detection circuit 12 may include a detection resistor R_{NF} arranged on a path for the fan motor 6, and an amplifier AMP1 configured to detect voltage drop that occurs between both terminals of the detection resistor R_{NF}. In a case in which the driving unit 10 includes a bridge circuit or an amplifier, the on-resistance of a transistor which is a component of such a bridge circuit or an amplifier, and which is arranged on a path for the driving current i_{DRV}(t), may be used as the detection resistor R_{NF}.

The back electromotive force estimation circuit 14 estimates the back electromotive force Em(t) that occurs at the coil based upon the driving signal S_{DRV} that represents the driving voltage V_{DRV} and a detection signal S_{IL}. The back electromotive force thus estimated and a signal that represents the back electromotive force thus estimated will be represented by Emₕₐₜ(t).

The driving signal generating unit 16 generates a driving signal S_{DRV} based upon the driving signal S_{DRV} (or driving voltage V_{DRV}) and the back electromotive force estimation signal Emₕₐₜ. The driving signal generating unit 16 adjusts the phase of the driving signal S_{DRV} such that timing of the zero-crossing point of the waveform of the back electromotive force Emₕₐₜ(t) thus estimated matches the timing of the zero-crossing point of the coil current i_{DRV}(t) represented by the detection signal S_{CS}. Thus, such an arrangement provides minimized noise and vibration, and provides reduced power consumption.

The driving signal generating unit 16 includes waveform memory 20, a normalizing circuit 22, a PLL circuit 24, and a calculation unit 26. The normalizing circuit 22 normalizes the back electromotive force estimation signal Emₕₐₜ, and writes the back electromotive force estimation signal Emₕₐₜ thus estimated to the waveform memory 20. The waveform data thus written to the waveform memory 20 is read out in synchronization with a readout clock CLK output from the PLL circuit 24. The calculation unit 26 multiplies the waveform data thus read out from the waveform memory 20 by a torque setting value S_{TRQ} so as to generate the driving signal S_{DRV}. The PLL circuit 24 adjusts the frequency of the clock signal CLK such that the timing of the zero-crossing point of the waveform of the back electromotive force Emₕₐₜ(t) thus estimated matches the timing of the zero-crossing point of the coil current i_{DRV}(t) represented by the detection signal S_{CS}.

The above is the overall configuration of the driving IC 100. Next, description will be made regarding the estimation of the back electromotive force.

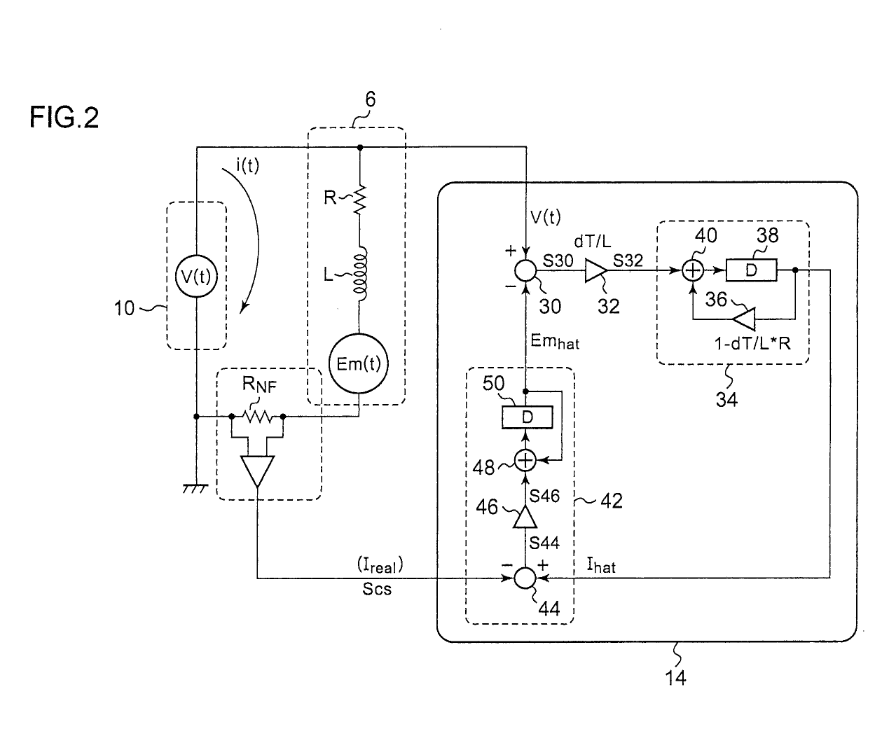

FIG. 2 is a circuit diagram which shows a configuration of the back electromotive force estimation circuit 14. The back electromotive force estimation circuit 14 includes a ninth calculation unit 30, a tenth calculation unit 32, a current estimation circuit 34, and a back electromotive force calculation unit 42. As described above, the back electromotive force estimation circuit 14 generates the back electromotive force estimation signal Emₕₐₜ which represents the estimated value of the back electromotive force that occurs at the coil, based upon the driving signal S_{DRV} and the detection signal S_{CS}.

The back electromotive force estimation circuit 14 is configured as a digital circuit. The sampling period will be represented by dT. Furthermore, the resistance value R and the inductance value L of the fan motor 6 are taken to be known.

The ninth calculation unit 30 calculates the difference between the driving signal S_{DRV} and the back electromotive force estimation signal Emₕₐₜ. The tenth calculation unit 32 multiplies output data S30 of the ninth calculation unit 30 by a coefficient (dT/L).

The current estimation circuit 34 estimates a current i(t) that flows through the coil, based upon output data S32 of the tenth calculation unit 32, and generates a current estimation signal Iₕₐₜ which represents the current value thus estimated. The current estimation circuit 34 includes an eleventh calculation unit 36, a delay circuit 38, and a twelfth calculation unit 40. The eleventh calculation unit 36 multiplies the current estimation signal Iₕₐₜ by a coefficient (1−Td/L×R). The twelfth calculation unit generates the sum of the output data of the tenth calculation unit 32 and the output data of the eleventh calculation unit 36. The delay circuit 38 delays the output data of the twelfth calculation unit 40 by the delay time dT, so as to generate the current estimation signal Iₕₐₜ.

The back electromotive force calculation unit 42 generates the back electromotive force estimation signal Emₕₐₜ such that the difference between the actual current value Iᵣₑₐₗ represented by the detection signal S_{CS} and the current value Iₕₐₜ thus estimated becomes zero. The back electromotive force calculation unit 42 includes a thirteenth calculation unit 44, a fourteenth calculation unit 46, a fifteenth calculation unit 48, and a delay circuit 50.

The thirteenth calculation unit 44 calculates the difference between the detection signal S_{CS} and the current estimation signal Iₕₐₜ. The fourteenth calculation unit 46 multiplies the difference data S44 by a predetermined coefficient. The fifteenth calculation unit 48 generates the sum of the back electromotive force estimation signal Emₕₐₜ and the output data S44 of the thirteenth calculation unit 44. The delay circuit 50 delays the output data S48 of the fifteenth calculation unit 48 by a delay time unit period dT, and outputs the resulting signal as the current estimation signal Iₕₐₜ.

The above is the configuration of the back electromotive force estimation circuit 14. Next, description will be made regarding its operating mechanism. When the driving voltage V(t) is applied to the fan motor 6, the following relation expression holds true.

V(t)=Em(t)+R i(t)+L d/dt i(t) (1)

The back electromotive force estimation circuit 14 is configured to perform digital signal processing. Thus, Expression (1) is transformed into a discrete-time system using the sampling time dT, thereby obtaining the following Expression (2).

Vₙ=Emₙ+R iₙ+L(iₙ₊₁−iₙ)/dT (2)

Expression (2) is solved for iₙ₊₁, thereby obtaining the following Expression (3).

iₙ₊₁=(1−dT/L×R)iₙ+dT/L×(Vₙ−Emₙ) (3)

With the back electromotive force estimation circuit 14 shown in FIG. 2, the estimated value Emₕₐₜ of the back electromotive force is updated by a feedback operation such that the estimated current value Iₕₐₜ matches the actual current value Iᵣₑₐₗ. When these two current values match each other, the feedback loop enters the steady state. In this state, the back electromotive force estimation signal represents the actual back electromotive force.

Thus, the back electromotive force estimation circuit 14 shown in FIG. 2 is capable of estimating the back electromotive force that occurs at the fan motor 6.

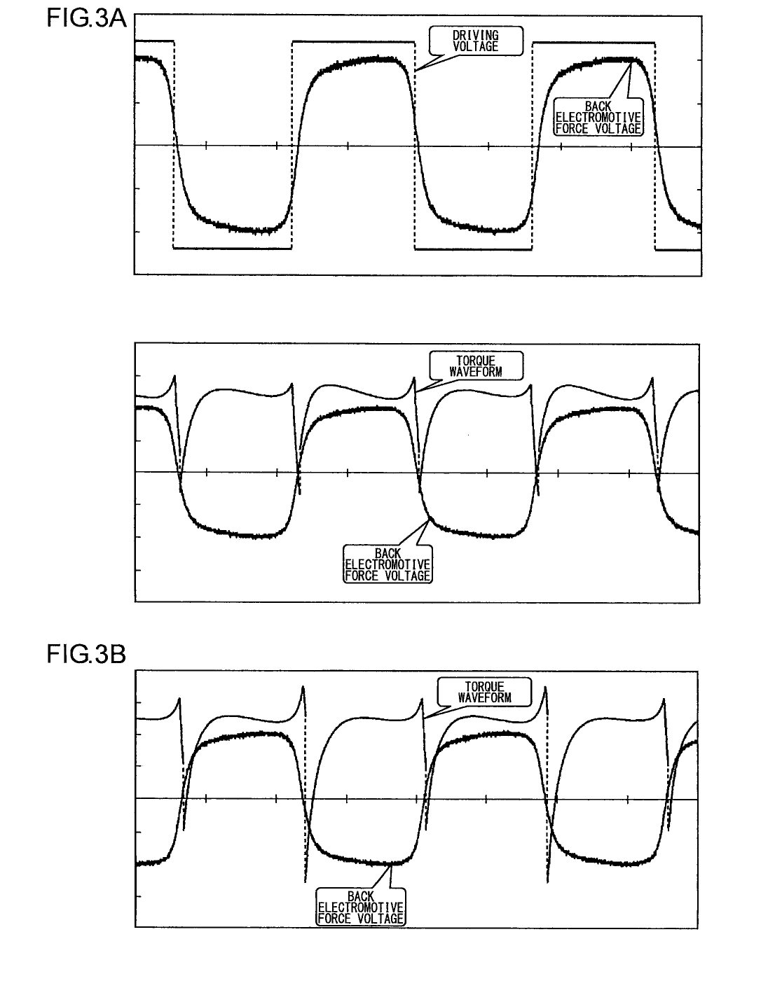

FIG. 3A is a driving waveform diagram for the driving IC 100 shown in FIG. 1. FIG. 3B is a driving waveform diagram for an arrangement employing a Hall sensor.

With an arrangement employing such a Hall sensor, the motor driving phase is switched based upon a Hall signal received from the Hall sensor. With such an arrangement, a large negative torque component occurs at each phase switching timing as shown in FIG. 3B. This is because there is a phase difference between the Hall signal and the back electromotive force that occurs in the motor. Such a negative torque leads to deterioration in the driving efficiency of the motor.

In contrast, with the driving IC 100 shown in FIG. 1, as shown in FIG. 3A, the phase of the driving voltage is adjusted such that the zero-crossing point of the driving current, i.e., the zero-crossing point of the torque waveform of the motor, matches the zero-crossing point of the back electromotive force. Thus, such an arrangement suppresses the occurrence of such a negative torque, thereby enabling the motor to be driven with high efficiency. The driving method according to the embodiment has advantages of improved noise and improved vibration in comparison with driving methods employing a Hall sensor or a velocity sensor.

Assuming that the resistance R and the inductance L of the fan motor 6 are each known, the back electromotive force estimation circuit 14 shown in FIG. 2 is capable of estimating the back electromotive force with high precision. However, the inductance L and the resistance R of the motor fluctuate dynamically in the driving operation of the motor. Accordingly, if the same resistance value R and the same inductance value L are used continuously, such an arrangement is not capable of estimating the back electromotive force. In order to solve such a problem, description will be made below regarding a technique for estimating the resistance R and the inductance L of the motor with high precision.

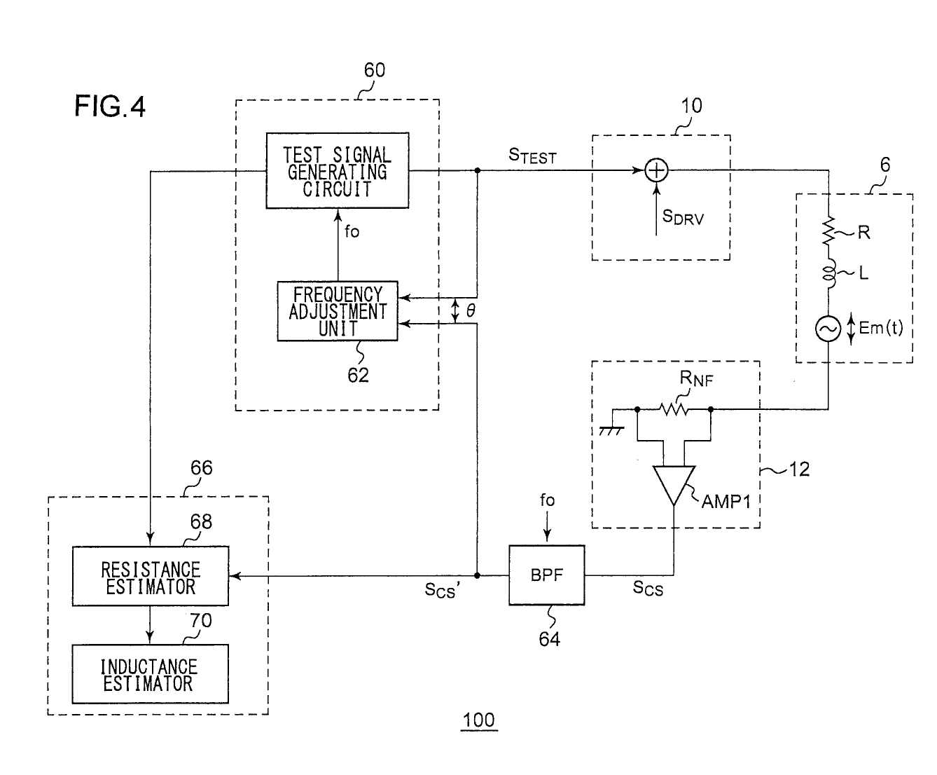

FIG. 4 is a block diagram which shows a part of the configuration of the driving IC 100. Of the configuration of the driving IC 100, FIG. 4 shows only a block configured to provide a function of estimating and calculating the constants R and L of the fan motor 6, and the other blocks are not shown.

The driving IC 100 includes a driving unit 10, a current detection circuit 12, a test signal generating circuit 60, a filter 64, and a coil constant calculation circuit 66.

The test signal generating circuit 60 generates an AC test signal S_{TEST}. For example, the test signal S_{TEST} is configured as a sine wave signal, and is represented by the following Expression.

S_{TEST}(t)=A sin(ω₀t)

A represents the amplitude of the test signal S_{TEST}, and ω represents the angular velocity (2πf₀). For example, in a case in which the fan motor 6 is rotationally driven in a range of 0 to 4000 rpm, the frequency of the motor is set to 0 to 70 Hz. The frequency of the test signal S_{TEST} is set to a value that is sufficiently higher than the frequency of the motor, and is preferably set to a value that is ten times to fifty times the frequency of the motor, for example. Specifically, the frequency f₀ of the test signal S_{TEST} is set to 1 kHz.

The driving unit 10 corresponds to that shown in FIG. 1. The driving unit 10 supplies, to the fan motor 6, a driving voltage V_{DRV} on which the test signal S_{TEST} has been superimposed. With an arrangement configured to perform a BTL driving operation, the test signal S_{TEST} is superimposed in the amplitude direction of the driving signal V_{DRV}. With an arrangement configured to perform a PWM driving operation, the test signal S_{TEST} is superimposed in the pulse width direction of the PWM pulse.

The current detection circuit 12 generates a detection signal S_{CS} that corresponds to the actual current i(t) that flows through the coil of the fan motor 6. The filter 64 is a bandpass filter configured to extract, from the detection signal S_{CS}, the frequency component that corresponds to the test signal S_{TEST}. The filter 64 is tuned so as to have a pass band including the frequency f₀. The output signal S_{CS}′ (which will be referred to as the “detection signal” hereafter) of the filter 64 is represented by the following Expression.

S_{CS}′(t)=B sin(ω₀t+θ)

The coil constant calculation circuit 66 calculates the resistance value R and the inductance value L of the fan motor 6 based upon the amplitudes A and B of the test signal S_{TEST} and the detection signal S_{CS}′ and the phase difference between these signals.

The above is the basic configuration of the driving IC 100. Next, description will be made regarding its operating mechanism.

In general, if the motor is stationary, the resistance value R can be calculated based upon the current that flows through the coil when a voltage is applied to the coil. Furthermore, the inductance value L can be calculated based upon the current waveform obtained when a voltage is applied in a step response manner. However, such a method cannot be used in the operation of rotationally driving the motor.

The Laplace transform of Expression (1) is generated so as to provide the transfer function for the current with respect to the driving voltage.

I(s)/(V(s)−Em(s))=1/R×1/(1+L/R s) (4)

That is to say, it can be understood that the current waveform I is represented by a waveform obtained by applying a first-order low-pass filter to the voltage waveform, and the amplitude thereof is represented by 1/R.

Now, the voltage V(t) represented by the following Expression (5) is taken to be applied to the motor.

V(t)=Const+A sin(ωt) (5)

The back electromotive force provides a voltage that is proportional to the rotational speed of the motor. Here, an AC driving voltage V(t)=B sin(ω₀t) that is insufficient to rotate the fan motor 6 is taken to be applied to the fan motor 6. When the motor is not rotated, the driving voltage V(t) has no effect on the back electromotive force. If there is a sufficiently great difference between ω and the frequency of the control voltage Const, the control voltage Const can be regarded as a DC voltage. The transfer function configured to represent the relation between the signal BPF_I(s) obtained by applying a bandpass filter having a center frequency f=2πω to the current I(s) and the AC component V′(t)=A sin(ωt) is represented by a transfer function of a first-order low-pass filter as represented in Expression (4). This transfer function is dependent on neither the back electromotive force Em nor the control voltage Const.

BPF_{—}I(t)/V′(s)=1/R×1/(1+L/R s) (6)

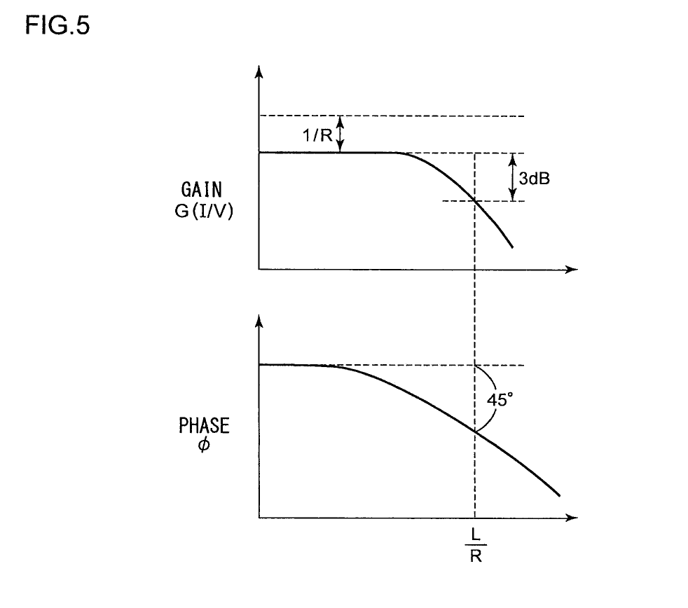

FIG. 5 shows graphs each showing the frequency response characteristics of the coil current with respect to the test signal S_{TEST} supplied to the fan motor 6. The upper graph shows the gain characteristics thereof (i.e., the amplitude ratio between the test signal and the output signal of the filter). The lower graph shows the phase characteristics thereof.

The gain characteristics and the phase characteristics are uniquely determined by the values of R and L. Thus, after the amplitudes A and B of the test signal S_{TEST} and the detection signal S_{CS}′ and the phase difference θ between these signals are acquired, the coil constant calculation circuit 66 is capable of calculating the values of R and L with high precision based upon the information thus acquired. The test signal S_{TEST} is configured as an AC signal, and has no effect on the driving operation for the fan motor 6. Thus, such an arrangement is capable of calculating the resistance value R and the inductance value L of the fan motor 6 while the fan motor 6 is being driven. Accordingly, such an arrangement is capable of detecting fluctuation in the resistance R and the inductance L in the driving operation even if the resistance R and the inductance L fluctuate. Thus, such an arrangement is capable of estimating the back electromotive force that occurs in the fan motor 6 with high precision.

Acquisition of the respective amplitudes A and B of the test signal S_{TEST} and the detection signal S_{CS}′ and of the phase difference θ between these signals leads to an increase in the amount of calculation, which is troublesome. Description will be made below regarding an operation for reducing the amount of calculation.

With the present embodiment, the test signal generating circuit 60 adjusts the frequency f₀ of the test signal S_{TEST} such that the phase difference θ between the two signals, i.e., the test signal S_{TEST} and the detection signal S_{CS}′ becomes a predetermined target value. With such a technique, the coil constant calculation circuit 66 is capable of calculating the resistance value R and the inductance value L on the assumption that the phase difference θ between the detection signal S_{CS}′ and the test signal S_{TEST} matches the target value, thereby providing a reduced amount of calculation.

The test signal generating circuit 60 includes a frequency adjustment unit 62. The frequency adjustment unit 62 controls the frequency f0 of the test signal S_{TEST} such that the phase difference θ between the test signal S_{TEST} and the detection signal S_{CS}′ becomes the target value.

For example, the target value of the phase difference θ is preferably set to 45°. The frequency which provides the phase difference θ=45° matches the cutoff frequency for a gain of −3 dB, and accordingly, the following Expression holds true. Here, A is a known value, and B represents the amplitude of the detection signal S_{CS}′. Accordingly, the resistance value R and the inductance value L can be calculated based upon a simple calculation.

R=A/B×10^{-3/20}=0.7×A/B [Ω]

L=R/ω₀ [H], which is obtained from ω₀=1/(L/R)=R/L.

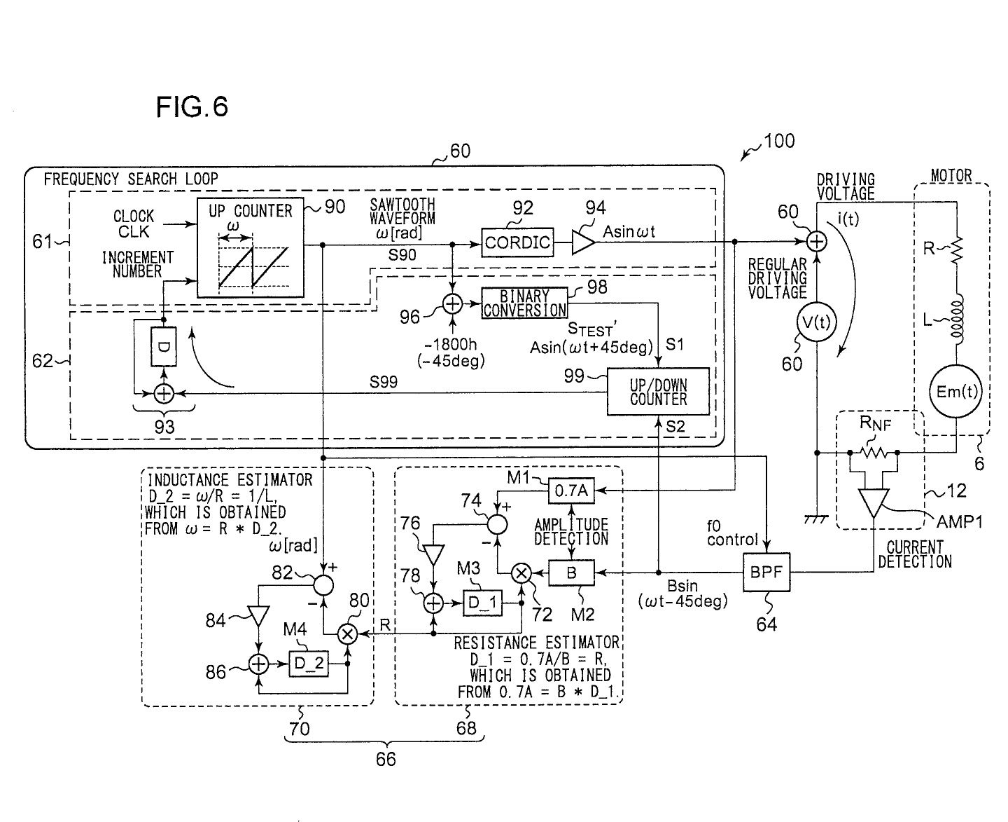

FIG. 6 is a circuit diagram which shows a specific example configuration of the driving IC 100 shown in FIG. 4.

The coil constant calculation circuit 66 includes a resistance estimator 68 and an inductance estimator 70. The resistance estimator 68 calculates the resistance R of the fan motor 6 by multiplying the value A/B, which is obtained by dividing the amplitude A of the test signal S_{TEST} by the amplitude B of the extracted detection signal S_{CS}′, by a predetermined coefficient α=0.7 that corresponds to the target value (45°).

The resistance estimator 68 includes memory units M1 through M3, a first calculation unit 72, a second calculation unit 74, a third calculation unit 76, and a fourth calculation unit 78. The memory unit M1 stores a value obtained by multiplying the amplitude A of the test signal S_{TEST} by the coefficient 0.7. The second memory unit M2 stores the peak value B of the detection signal S_{CS}′. The memory unit M3 stores the data D_1 which represents the calculated resistance value R.

The first calculation unit 72 multiplies the value stored in the memory unit M2 by the value D_1 stored in the memory unit M3. The second calculation unit 74 subtracts the output data of the first calculation unit 72 from the data 0.7 A stored in the memory unit Ml. The third calculation unit 76 converts the output data of the second calculation unit 74 into multi-valued data (e.g., binary data). The fourth calculation unit 78 generates the sum of the value stored in the memory unit M3 and the output data of the second calculation unit 74, and stores the resulting data in the memory unit M3 as the updated data D_1. By means of such an operation, the value stored in the memory unit M3 represents the resistance value R.

The inductance estimator 70 receives, as input data, the data ω which represents the frequency of the test signal S_{TEST}. The inductance estimator 70 includes a memory unit M4, a fifth calculation unit 80, a sixth calculation unit 82, a seventh calculation unit 84, and an eighth calculation unit 86. The memory unit M4 stores data D_2 which represents the calculated inductance value L. The fifth calculation unit 80 multiplies the inductance value L stored in the memory M4 by the resistance value R. The sixth calculation unit 82 calculates the difference between the data which represents the frequency ω of the test signal S_{TEST} and the output data of the fifth calculation unit 80. The seventh calculation unit 84 converts the output data of the sixth calculation unit 82 into multi-valued data. The eighth calculation unit 86 generates the sum of the inductance value L stored in the memory M4 and the output data of the seventh calculation unit 84, and stores the resulting value in the memory M4, thereby updating the inductance value L. By means of such an operation, the value stored in the memory M4 represents the inductance value L.

Next, description will be made regarding a configuration of the test signal generating circuit 60. The test signal generating circuit 60 includes a signal source 61 and a frequency adjustment unit 62.

The signal source 61 includes a counter 90, a CORDIC 92, an amplitude adjustment unit 94, a calculation unit 96, a calculation unit 98, an up/down counter 99, and a compensator 93.

The counter 90 performs a counting up operation according to the clock signal CLK so as to generate phase count data S90 having a sawtooth waveform having a period T (=2π/ω₀) that corresponds to the frequency ω₀ of the test signal S_{TEST}. The frequency ω₀ changes according to the increment value δ in increments of cycles of the clock signal CLK applied to the counter 90. The phase count data S90 is data that corresponds to (ω₀t) in Expression (5).

The CORDIC 92 receives the phase count data S90 from the counter 90, and converts the value of the phase count data S90 thus received into a normalized trigonometric function value. The amplitude adjustment unit 94 converts the amplitude of the output data of the CORDIC 92 into the aforementioned value A.

The up/down counter 99 receives the data S1 that represents the sign of the data, which is obtained by shifting the count data S90 by a value that corresponds to the target phase value 45°, and receives the data that represents the sign of the detection signal S_{CS}′ output from the filter 64. The up/down counter 99 performs a counting up operation according to one of the data thus received, and performs a counting down operation according to the other data.

The count value S99 of the up/down counter 99 represents the difference between a target value and the phase difference θ between the two signals S_{TEST} and S_{CS}′. The compensator 93 integrates the error data S99, and outputs the resulting data to the counter 90. The counter 90 controls the period T of the phase count data S90, i.e., the increment value, based upon the error data S99, and, more specifically, upon the integrated value of the error data S99.

The first signal S1 is generated by the calculation unit 96 and the calculation unit 98. The calculation unit 96 generates the sum of the phase count data S90 and the value “−1800 h” that corresponds to the target phase value −45°, thereby shifting the phase count data S90. That is to say, the phase is advanced by 45°. The calculation unit 98 compares the output data of the calculation unit 96 with a predetermined threshold value so as to convert the output data of the calculation unit 96 into binary data. Such conversion into binary data is performed such that the first signal S1 represents the sign of the signal S_{TEST}′ having a phase that is advanced by 45° with respect to the test signal TEST. The sign bit of the detection signal S_{CS}′ may be used as the second signal S2.

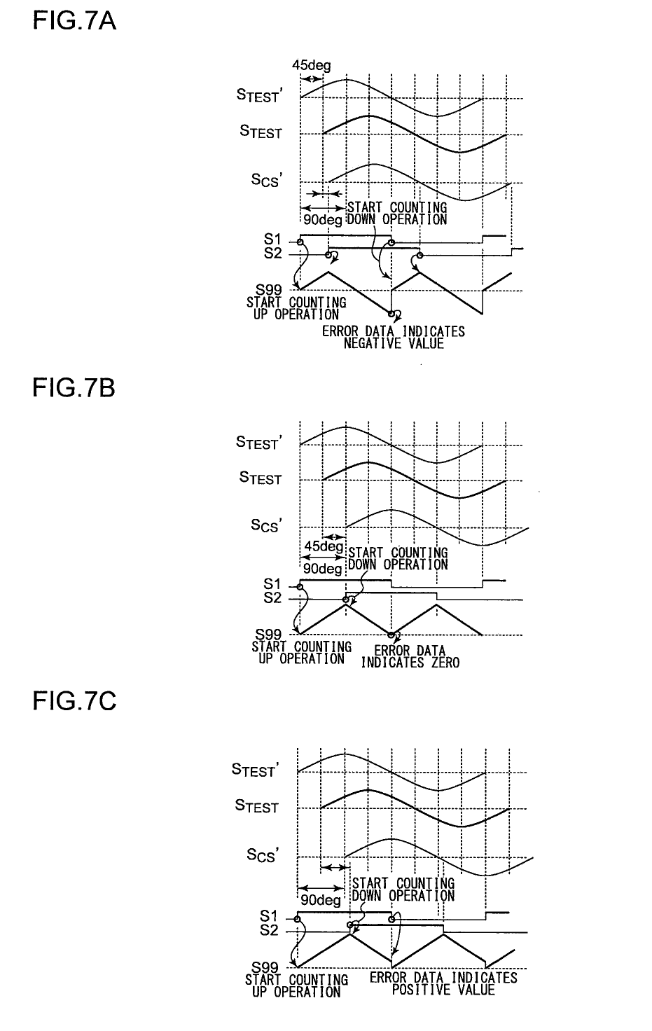

FIGS. 7A through 7C are graphs each showing an operating waveform for the test signal generating circuit 60 shown in FIG. 6. The error data S99 changes according to the phase difference between the two signals S_{TEST} (S_{TEST}′) and S_{CS}′. FIG. 7A shows a case in which the phase difference between the signal S_{TEST} and the detection signal S_{CS}′ is smaller than the target value, FIG. 7B shows a case in which the phase difference matches the target value, and FIG. 7C shows a case in which the phase difference is greater than the target value.

When the phase difference between the test signal S_{TEST}′ and the detection signal S_{CS}′ matches 90° as shown in FIG. 7B, i.e., when the phase difference between the test signal S_{TEST} and the detection signal S_{CS}′ matches the target value 45°, the error data S99 becomes zero at each zero-crossing timing of the test signal S_{TEST}′.

When the phase difference θ is smaller than the target value 45° as shown in FIG. 7A, the error data S99 is a negative value. In this case, as clearly understood with reference to FIG. 5, there is a need to raise the frequency of the test signal S_{TEST}. Accordingly, the counter 90 increases the increment value.

Conversely, when the phase difference θ is greater than the target value 45° as shown in FIG. 7C, the error data S99 is a positive value. In this case, as clearly understood with reference to FIG. 5, there is a need to reduce the frequency of the test signal S_{TEST}. Accordingly, the counter 90 reduces the increment value.

With the test signal generating circuit 60 shown in FIG. 6, a feedback operation is performed such that the error data S99 becomes zero, thereby adjusting the frequency ω₀ such that the phase difference θ become 45°.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

Description has been made in the embodiment regarding an arrangement in which the frequency of the test signal S_{TEST} is adjusted such that the phase difference θ between the test signal S_{TEST} and the detection signal S_{CS}′ becomes 45°. However, the present invention is not restricted to such an arrangement. Also, other values may be used as the target value of the phase difference θ.

Description has been made in the embodiment regarding an arrangement configured to drive the fan motor 6. However, the present invention is not restricted to such an arrangement. Also, the present invention may be used to drive other kinds of motors.

While the preferred embodiments of the present invention have been described using specific terms, such description is for illustrative purposes only, and it is to be understood that changes and variations may be made without departing from the spirit or scope of the appended claims.

1. A driving circuit configured to drive a motor having a resistance and an inductance, the driving circuit comprising:
a test signal generating circuit configured to generate an AC test signal;
a driving unit configured to supply, to the motor, a driving signal on which the test signal has been superimposed;
a current detection circuit configured to generate a detection signal that corresponds to an actual current that flows through a coil included in the motor;
a filter configured to extract a frequency component that corresponds to the test signal from the detection signal; and
a coil constant calculation circuit configured to calculate the resistance value and the inductance value of the motor based upon the amplitude of a detection signal output from the filter, the amplitude of the test signal, and the phase difference between these two signals.

2. A driving circuit according to claim 1, wherein the test signal generating circuit is configured to adjust the frequency of the test signal such that the phase difference between the test signal and the detection signal output from the filter becomes a predetermined target value.

3. A driving circuit according to claim 2, wherein the target value is substantially 45 degrees.

4. A driving circuit according to claim 2, wherein the coil constant calculation circuit comprises a resistance estimator configured to calculate the resistance value of the motor by multiplying a value, which is obtained by dividing the amplitude of the test signal by the amplitude of the detection signal output from the filter, by a predetermined coefficient that corresponds to the target value.

5. A driving circuit according to claim 4, wherein the resistance estimator comprises:
memory configured to store a calculated resistance value;
a first calculation unit configured to multiply the resistance value stored in the memory by the amplitude of the detection signal output from the filter;
a second calculation unit configured to calculate the difference between the output data of the first calculation unit and a value obtained by multiplying the amplitude of the test signal by a predetermined coefficient;
a third calculation unit configured to convert the output data of the second calculation unit into multi-valued data; and
a fourth calculation unit configured to generate the sum of the resistance value stored in the memory and the output data of the third calculation unit, and to store the value thus obtained in the memory, thereby updating the resistance value.

6. A driving circuit according to claim 2, wherein the coil constant calculation circuit comprises an inductance estimator configured to calculate the inductance value of the motor by dividing the resistance value thus calculated by a value that corresponds to the frequency of the test signal.

7. A driving circuit according to claim 6, wherein the inductance estimator comprises:
memory configured to store a calculated inductance value;
a fifth calculation unit configured to multiply the inductance value stored in the memory by the resistance value;
a sixth calculation unit configured to calculate the difference between the data that represents the frequency of the test signal and the output data of the fifth calculation unit;
a seventh calculation unit configured to convert the output data of the sixth calculation unit into multi-valued data; and
an eighth calculation unit configured to generate the sum of the inductance value stored in the memory and the output data of the seventh calculation unit, and to store the value thus obtained in the memory, thereby updating the inductance value.

8. A driving circuit according to claim 2, wherein the test signal generating circuit comprises:
a counter configured to generate count data having a sawtooth waveform having a period that corresponds to the frequency of the test signal;
a CORDIC (COordinate Rotation DIgital Computer) configured to receive the count data from the counter, and to convert the count data thus received into a trigonometric function value; and
an up/down counter configured to receive a first signal, which is obtained by converting, into binary data, data that is obtained by shifting the count data by an amount that corresponds to the target value, and a second signal, which represents the sign of the detection signal output from the filter, and to perform a counting up operation according to one of the data thus received, and to perform a counting down operation according to the other data thus received,
and wherein the counter controls the period of the count data based upon the output data of the up/down counter.

9. A driving circuit according to claim 1, further comprising a back electromotive force estimation circuit configured to generate a back electromotive force estimation signal that represents an estimated value of the back electromotive force that occurs in the coil, based upon a driving signal that corresponds to the driving voltage and the detection signal,
wherein, with the sampling period as dT, and with the resistance of the motor as R and the inductance of the motor as L, the back electromotive force estimation circuit comprises:
a ninth calculation unit configured to calculate the difference between the driving signal and the back electromotive force estimation signal;
a tenth calculation unit configured to multiply the output data of the ninth calculation unit by dT/L;
a current estimation circuit configured to estimate a current that flows through the coil, based upon the output data of the tenth calculation unit, comprising an eleventh calculation unit configured to multiply the estimated current value by (1−dT/L×R), a twelfth calculation unit configured to generate the sum of the output data of the tenth calculation unit and the output data of the eleventh calculation unit, and a delay circuit configured to delay the output data of the twelfth calculation unit by a period dT and to output the current value thus estimated as output data; and
a back electromotive force calculation unit configured to generate the back electromotive force estimation signal such that the difference between the actual current value represented by the detection signal and the current value thus estimated becomes zero.

10. A driving circuit according to claim 9, wherein the driving unit adjusts the phase of the driving voltage such that the timing of the zero-crossing point of a waveform represented by the back electromotive force estimation signal matches the timing of the zero-crossing point of the current represented by the detection signal.

11. A cooling apparatus comprising:
a fan motor having a resistance and an inductance; and
a driving circuit configured to drive the fan motor, the driving circuit comprising:
a test signal generating circuit configured to generate an AC test signal;
a driving unit configured to supply, to the motor, a driving signal on which the test signal has been superimposed;
a current detection circuit configured to generate a detection signal that corresponds to an actual current that flows through a coil included in the motor;
a filter configured to extract a frequency component that corresponds to the test signal from the detection signal; and
a coil constant calculation circuit configured to calculate the resistance value and the inductance value of the motor based upon the amplitude of a detection signal output from the filter, the amplitude of the test signal, and the phase difference between these two signals.

12. An electronic device comprising:
a processor; and
a cooling apparatus configured to cool the processor, the cooling apparatus comprising:
a fan motor having a resistance and an inductance; and
a driving circuit configured to drive the fan motor, wherein the driving circuit comprises:
a test signal generating circuit configured to generate an AC test signal;
a driving unit configured to supply, to the motor, a driving signal on which the test signal has been superimposed;
a current detection circuit configured to generate a detection signal that corresponds to an actual current that flows through a coil included in the motor;
a filter configured to extract a frequency component that corresponds to the test signal from the detection signal; and
a coil constant calculation circuit configured to calculate the resistance value and the inductance value of the motor based upon the amplitude of a detection signal output from the filter, the amplitude of the test signal, and the phase difference between these two signals.

13. A method for estimating the resistance and the inductance of a motor, the method comprising:
superimposing an AC test signal on a driving voltage to be applied to the motor;
generating a detection signal that corresponds to an actual current that flows through a coil included in the motor;
extracting a frequency component that corresponds to the test signal from the detection signal; and
calculating the resistance value and the inductance value of the motor based upon at least one of the amplitude of the extracted detection signal, the amplitude of the test signal, and the phase difference between these two signals.

14. A method according to claim 13, further comprising adjusting the frequency of the test signal such that the phase difference between the extracted detection signal and the test signal becomes a predetermined target value.

15. A method according to claim 14, wherein the target value is substantially 45 degrees.

16. A method according to claim 14, further comprising:
calculating the resistance value of the motor by multiplying a value, which is obtained by dividing the amplitude of the test signal by the amplitude of the detection signal thus extracted, by a predetermined coefficient; and
calculating the inductance value of the motor by dividing the resistance value thus calculated by a value that corresponds to the frequency of the test signal.
